(19) United States
(12) Patent Application Publication
(10) Pub. No.: US 2026/0070464 A1
(43) Pub. Date: Mar. 12, 2026

(54) DC BIDIRECTIONAL CHARGING AND DISCHARGING SYSTEM AND CONTROL METHOD THEREOF AND CHARGING PILLAR

(71) Applicant: Starcharge Energy Pte Ltd, Singapore (SG)

(72) Inventors: YU-MING CHANG, Singapore (SG); HSIEN-YI TSAI, Singapore (SG); TSUNG-YUAN WU, Singapore (SG)

(73) Assignee: Starcharge Energy Pte Ltd, Singapore (SG)

(21) Appl. No.: 18/827,820

(22) Filed: Sep. 8, 2024

(51) Int. Cl. B60L 55/00; B60L 53/16; B60L 53/31; B60L 53/62

(52) U.S. Cl. CPC B60L 55/00; B60L 53/16; B60L 53/31; B60L 53/62; B60L 2210/10

(57) ABSTRACT

The disclosure relates to charging and discharging technologies, and in particular to a DC bidirectional charging and discharging system, a control method thereof and a charging pillar. The system includes: first to X-th bidirectional DCDC modules; first to Y-th charging ports, a first series-parallel circuit, a second series-parallel circuit, and a controller, wherein the first side of the first series-parallel circuit is connected to the first side of the bidirectional DCDC modules, and the second side of the first series-parallel circuit is connected to the charging ports; the first side of the second series-parallel circuit is connected to the DC power grid, and the second side of the second series-parallel circuit is connected to the second side of the bidirectional DCDC modules; the controller is configured to control the first series-parallel circuit and the second series-parallel circuit.

### BACKGROUND

### Technical Field

The disclosure relates to the technical field of charging device, and in particular to a DC bidirectional charging and discharging system, a control method thereof and a charging pillar.

### Description of Related Art

With the development of automobile industry, electric vehicles have become the mainstream of the development in the future. The batteries disposed inside new energy vehicles normally adopt high-power DC for charging, wherein AC to DC power modules are adopted, the input is AC power supply and the output is DC for charging the battery. However, when the input is from AC power supply, the power supply efficiency is poor, and it is not easy to implement a two-way charging and discharging system. Therefore, existing new power supply systems normally adopt smart microgrid systems with DC input, which may achieve bidirectional charging and discharging. Because generally adopted independent DC-to-DC power modules have a wide range of output voltage fluctuations at the application end, existing DC power modules are often limited by semiconductor voltage-resistant components and unable to provide a wide range of output, nor can they serve the function of full power charging.

### SUMMARY

In order to solve the above technical problems, the present disclosure provides a DC bidirectional charging and discharging system, a control method thereof and a charging pillar, which may realize the wide range of output of the DC bidirectional charging and discharging system, serve the function of full power charging, while input and output of each bidirectional DCDC module may be switched at will, so that each bidirectional DCDC module may achieve the maximum charging power or provide charging function for a maximum number of users within each voltage range, thereby improving charging and discharging efficiency.

The technical solutions adopted by the present disclosure are as follows.

A DC bidirectional charging and discharging system includes: first to X-th bidirectional DCDC modules; first to Y-th charging ports, wherein each of the charging ports is configured to connect to a corresponding device to be charged, wherein X and Y are integers greater than 1; a first series-parallel circuit, wherein a first side of the first series-parallel circuit is connected to a first side of the X bidirectional DCDC modules, and a second side of the first series-parallel circuit is connected to the Y charging ports to realize an electrical connection between the X bidirectional DCDC modules and the Y charging ports; a second series-parallel circuit, wherein a first side of the second series-parallel circuit is connected to a DC power grid, and a second side of the second series-parallel circuit is connected to a second side of the X bidirectional DCDC modules to realize an electrical connection between the DC power grid and the X bidirectional DCDC modules; a controller, wherein the controller is electrically connected to the first series-parallel circuit and the second series-parallel circuit respectively, the controller is configured to control the first series-parallel circuit to realize a series-parallel connection of a plurality of bidirectional DCDC modules on a charging side, and to control the second series-parallel circuit to realize a series-parallel connection of the plurality of bidirectional DCDC modules on a power supply side.

According to an embodiment of the present disclosure, the first series-parallel circuit includes a first series switch circuit and a first parallel switch circuit. The first series switch circuit is connected to the connection line between the first side of the X bidirectional DCDC modules and the first parallel switch circuit. The first series switch circuit is configured to realize the series connection of any amount of bidirectional DCDC modules on the charging side. The first parallel switch circuit includes Y groups of first parallel switch groups, and one end of each group of the first parallel switch groups is connected to a corresponding one of the charging port, the other ends of each group of the first parallel switch groups is connected to the first side of the X bidirectional DCDC modules through the first series switch circuit. The first parallel switch circuit is configured to realize the parallel connection of plurality of groups of bidirectional DCDC modules connected in series, and to connect the plurality of groups of bidirectional DCDC modules connected in series to corresponding charging ports.

According to an embodiment of the present disclosure, the first series switch circuit includes X*(X−1)/2 first series switches, and the main port on the first side of the i-th bidirectional DCDC module is connected to the secondary port on the first side of the i+1-th bidirectional DCDC module to the X-th bidirectional DCDC module in one-to-one correspondence through X−i first series switches, wherein 1≤i<X, and i is an integer.

According to an embodiment of the present disclosure, each group of the first parallel switch groups includes 2X first parallel switches, the main port on the first side of each bidirectional DCDC module is connected to the main port of each of the charging ports through the only corresponding first parallel switch, and the secondary port on the first side of each bidirectional DCDC module is connected to the secondary port of each of the charging ports through the only corresponding first parallel switch.

According to an embodiment of the present disclosure, the second series-parallel circuit includes a second series switch circuit and a second parallel switch circuit. The second series switch circuit is connected to the connection line between the second side of the X bidirectional DCDC modules and the second parallel switch circuit. The second series switch circuit is configured to realize the series connection of any amount of the bidirectional DCDC modules on the power supply side. The second parallel switch circuit includes Z groups of second parallel switch groups. One end of each second parallel switch group is connected to the DC power grid, and the other ends of each second parallel switch group is connected to the second side of the X bidirectional DCDC modules through the second series switch circuit. The second parallel switch circuit is configured to realize the parallel connection of the plurality of groups of bidirectional DCDC modules connected in series, and to connect the plurality of groups of bidirectional CDC modules connected in series to the DC power grid, wherein Z is an integer greater than 1.

According to an embodiment of the present disclosure, the first bidirectional DCDC module to the X-th bidirectional DCDC module are connected to one or more independent DC power grids through a second series-parallel circuit.

The present disclosure further provides a control method for the above-mentioned DC bidirectional charging and discharging system, and the method includes the following steps: determining the operating mode of the DC bidirectional charging and discharging system; when the charging side of the DC bidirectional charging and discharging system is in the output mode, controlling the first series-parallel circuit according to the external charging required voltage and the highest voltage level of the system to realize the series-parallel connection of the plurality of bidirectional DCDC modules on the charging side, so that the plurality of bidirectional DCDC modules charge the device to be charged through the plurality of the charging ports; when the power supply side of the DC bidirectional charging and discharging system is in the output mode, controlling the second series-parallel circuit according to the required voltage on the power supply side and the highest voltage level of the system to realize the series-parallel connection of the plurality of bidirectional DCDC modules on the power supply side, so that the plurality of bidirectional DCDC modules supply power to the DC power grid.

According to an embodiment of the present disclosure, when the charging side of the DC bidirectional charging and discharging system is in the output mode, controlling the first series-parallel circuit according to the external charging required voltage and the highest voltage level of the system specifically includes the following steps: obtaining the external charging required voltage; determining the maximum number of charging ports that the system is able to provide for charging and the number of bidirectional DCDC modules that need to work according to the external charging required voltage and the highest voltage level of the system; controlling the first series-parallel circuit so that the bidirectional DCDC module that needs to work supplies power to the charging port that needs to be charged; calculating the output voltage and the output power of each bidirectional DCDC module among the bidirectional DCDC modules that need to work according to the external charging required voltage, the number of charging ports that need to be charged, and the number of bidirectional DCDC modules that provide power for each of the charging ports that needs to be charged, and controlling each bidirectional DCDC module among the bidirectional DCDC modules that need to work to work with a corresponding output voltage and a corresponding output power.

According to an embodiment of the present disclosure, when the power supply side of the DC bidirectional charging and discharging system is in the output mode, controlling the second series-parallel circuit according to the required voltage on the power supply side and the highest voltage level of the system specifically includes the following steps: obtaining the required voltage on the power supply side; determining the number r of bidirectional DCDC modules connected in series to the DC power grid and the maximum number s of groups of bidirectional DCDC modules connected in parallel to the DC power grid according to the required voltage on the power supply side and the highest voltage level of the system, wherein r is an integer greater than 1 and less than or equal to X, s is an integer greater than or equal to 1 and less than or equal to Z, Z is the number of power transmission port groups through which the second series-parallel circuit is connected to the DC power grid; controlling the second series-parallel circuit so that r bidirectional DCDC modules are connected in series to the DC power grid on the power supply side, and s groups of bidirectional DCDC modules are connected in parallel to the DC power grid on the power supply side.

The present disclosure further provides a charging pillar, including the above-mentioned DC bidirectional charging and discharging system.

Advantageous effects of the present disclosure are as follows.

In the present disclosure, series-parallel circuits are provided on both sides of the bidirectional DCDC module, so that the controller may adjust the output voltage and input voltage of the bidirectional DCDC module by controlling the first series-parallel circuit and the second series-parallel circuit, thereby realizing the wide range of output of the DC bidirectional charging and discharging system, providing full power charging, and switching the input and output of each bidirectional DCDC module at will, so that each bidirectional DCDC module may achieve the maximum charging power or provide charging function for a maximum number of users within each voltage range, thereby improving charging and discharging efficiency.

### BRIEF DESCRIPTION OF THE DRAWINGS

FIG. 1 is a block diagram of a DC bidirectional charging and discharging system according to an embodiment of the present disclosure.

FIG. 2 is a schematic structural diagram of a first series switch circuit according to an embodiment of the present disclosure.

FIG. 3 is a schematic structural diagram of a first parallel switch circuit according to an embodiment of the present disclosure.

FIG. 4 is a flow chart of a control method of the DC bidirectional charging and discharging system according to an embodiment of the present disclosure.

### DESCRIPTION OF THE EMBODIMENTS

The technical solutions in the embodiments of the present disclosure will be clearly and completely described below with reference to the accompanying drawings in the embodiments of the present disclosure. Clearly, the described embodiments are only some of the embodiments of the present disclosure, rather than all the embodiments. Based on the embodiments of the present disclosure, all other embodiments obtained by those of ordinary skill in the art without creative efforts fall within the scope to be protected by the present disclosure.

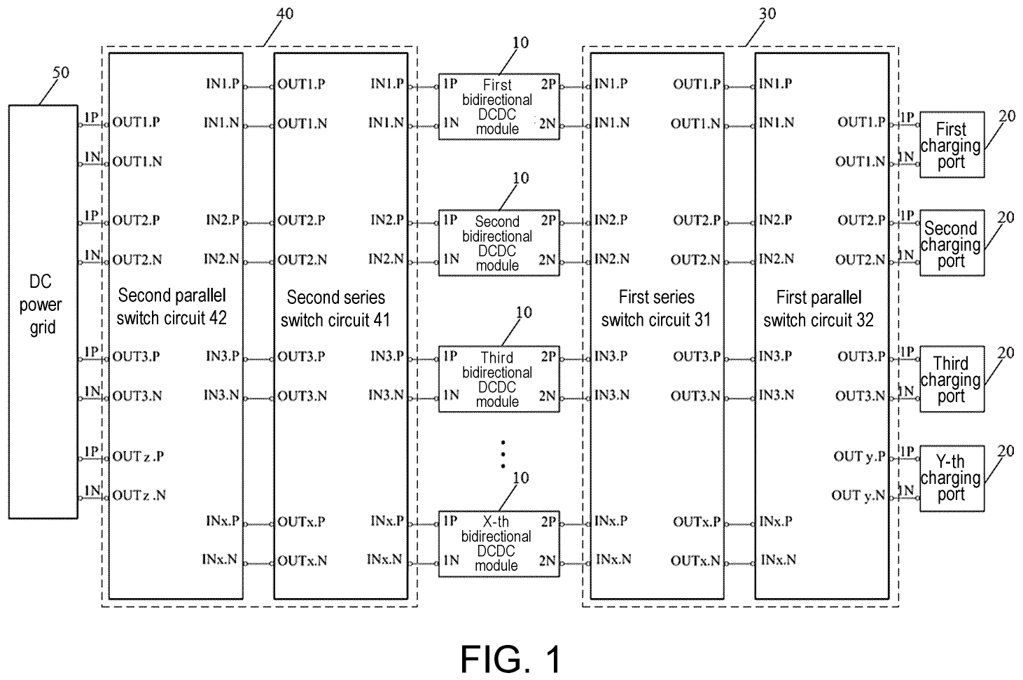

As shown in FIG. 1, the DC bidirectional charging and discharging system in the embodiment of the present disclosure includes: first to X-th bidirectional DCDC modules 10, first to Y-th charging ports 20, a first series-parallel circuit 30, a second series-parallel circuit 40 and a controller, wherein X and Y are both integers greater than 1, and each charging port is configured to be connected with the corresponding device to be charged. The first side of the first series-parallel circuit 30 is connected to the first side of the X bidirectional DCDC modules 10, and the second side of the first series-parallel circuit 30 is connected to the Y charging ports 20 to realize the electrical connection between the X bidirectional DCDC modules 10 and the Y charging ports 20. The first side of the second series-parallel circuit 40 is connected to the DC power grid 50, and the second side of the second series-parallel circuit 40 is connected to the second side of the X bidirectional DCDC modules 10 to realize the electrical connection between the DC power grid 50 and the X bidirectional DCDC modules 10. The controller is electrically connected to the first series-parallel circuit 30 and the second series-parallel circuit 40 respectively. The controller is configured to control the first series-parallel circuit 30 to realize the series-parallel connection of the plurality of bidirectional DCDC modules 10 on the charging side, and to control the second series-parallel circuit 40 to realize the series-parallel connection of the plurality of bidirectional DCDC modules 10 on the power supply side, wherein the charging side is the side where the charging port 20 is located, and the power supply side is the side where the DC power grid 50 is located.

Since the first to X-th bidirectional DCDC modules 10 are all independent DC power modules, and the input and output may be switched freely, they may be combined into different voltage levels according to the requirement of the device to be charged to provide optimal power output. When the bidirectional DCDC module 10 charges the device to be charged through the charging port 20, the first side of the bidirectional DCDC module 10 is the output side. When the energy storage device discharges the bidirectional DCDC module 10 through the charging port 20, the first side of the bidirectional DCDC module 10 is the input side. When the DC power grid 50 charges the bidirectional DCDC module 10 through the second series-parallel circuit 40, the second side of the bidirectional DCDC module 10 is the input side. When the bidirectional DCDC module 10 discharges the DC power grid 50 through the second series-parallel circuit 40, the second side of the bidirectional DCDC module 10 is the output side.

In the DC bidirectional charging and discharging system of this embodiment, series-parallel circuits are provided on both sides of the bidirectional DCDC module 10, so that the controller may adjust the output voltage and input voltage of the bidirectional DCDC module 10 by controlling the first series-parallel circuit 30 and the second series-parallel circuit 40, thereby realizing the wide range of output of the DC bidirectional charging and discharging system, providing full power charging, and switching the input and output of each bidirectional DCDC module at will, so that each bidirectional DCDC module 10 may achieve the maximum charging power or provide charging function for a maximum number of users within each voltage range, thereby improving charging and discharging efficiency.

As shown in FIG. 1 to FIG. 3, in an embodiment of the present disclosure, the first series-parallel circuit 30 may include a first series switch circuit 31 and a first parallel switch circuit 32. The first series switch circuit 31 is connected to the connection line between the first side of the X bidirectional DCDC modules 10 and the first parallel switch circuit 32, and the first series switch circuit 31 is configured to realize the series connection of any amount of bidirectional DCDC modules 10 on the charging side. The first parallel switch circuit 32 includes Y groups of first parallel switch groups 321, and one end of each group of the first parallel switch groups 321 is connected to a corresponding one of the charging port 20, the other ends of each group of the first parallel switch groups 321 is connected to the first side of the X bidirectional DCDC modules 10 through the first series switch circuit 31. The first parallel switch circuit 321 is configured to realize the parallel connection of plurality of groups of bidirectional DCDC modules 10 connected in series, and to connect the plurality of groups of bidirectional DCDC modules 10 connected in series to corresponding charging ports 20.

In an embodiment of the present disclosure, the first series switch circuit 31 may include X*(X−1)/2 first series switches, and the main port on the first side of the i-th bidirectional DCDC module 10 is connected to the secondary port on the first side of the i+1-th to X-th bidirectional DCDC modules 10 in one-to-one correspondence through X−i first series switches, wherein 1≤i<X, and i is an integer. The one-to-one correspondence here refers to the one-to-one correspondence between the X−i first series switches and the main ports on the first side of the i+1-th to X-th bidirectional DCDC modules 10.

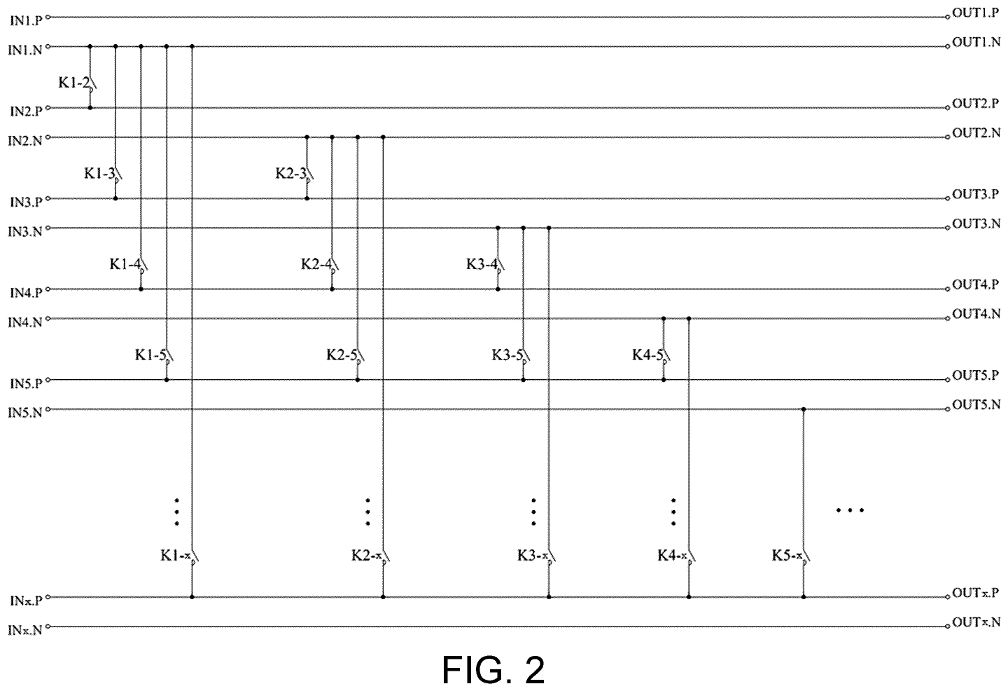

As shown in FIG. 2, the secondary port IN1.N on the first side of the first bidirectional DCDC module 10 is connected to the main port IN2.P on the first side of the second bidirectional DCDC module 10 through the first series switch K1-2. The secondary port IN1.N on the first side of the first bidirectional DCDC module 10 is connected to the main port IN3.P on the first side of the third bidirectional DCDC module 10 through the first series switch K1-3, . . . , the secondary port IN1.N on the first side of the first bidirectional DCDC module 10 is connected to the main port INx.P on the first side of the X-th bidirectional DCDC module 10 through the first series switch K1-x; the secondary port IN2.N on the first side of the second bidirectional DCDC module 10 is connected to the main port IN3.P on the first side of the third bidirectional DCDC module 10 through the first series switch K2-3, . . . , the secondary port IN5.N on the first side of the fifth bidirectional DCDC module 10 is connected to the main port INx.P on the first side of the X-th bidirectional DCDC module 10 through the first series switch K5-x.

That is to say, each first series switch in the first series switch circuit 31 is always connected between the secondary port on the first side of one bidirectional DCDC module 10 and the main port on the same side of another bidirectional DCDC module 10. Accordingly, it is possible to realize the series connection of any amount of bidirectional DCDC modules 10 on the charging side, thereby achieving series voltage boosting.

In an embodiment of the present disclosure, each group of first parallel switch groups 321 may include 2X first parallel switches, and the main port on the first side of each bidirectional DCDC module 10 is connected to the main port of each charging port 20 through the only corresponding first parallel switch, and the secondary port on the first side of each bidirectional DCDC module 10 is connected to the secondary port of each charging port 20 through the only corresponding first parallel switch. The one and only correspondence here refers to one first parallel switch corresponds to the main port on the first side of one bidirectional DCDC module 10 and the main port of the charging port 20, or corresponds to the secondary port on the first side of one bidirectional DCDC module 10 and the secondary port of the charging port 20.

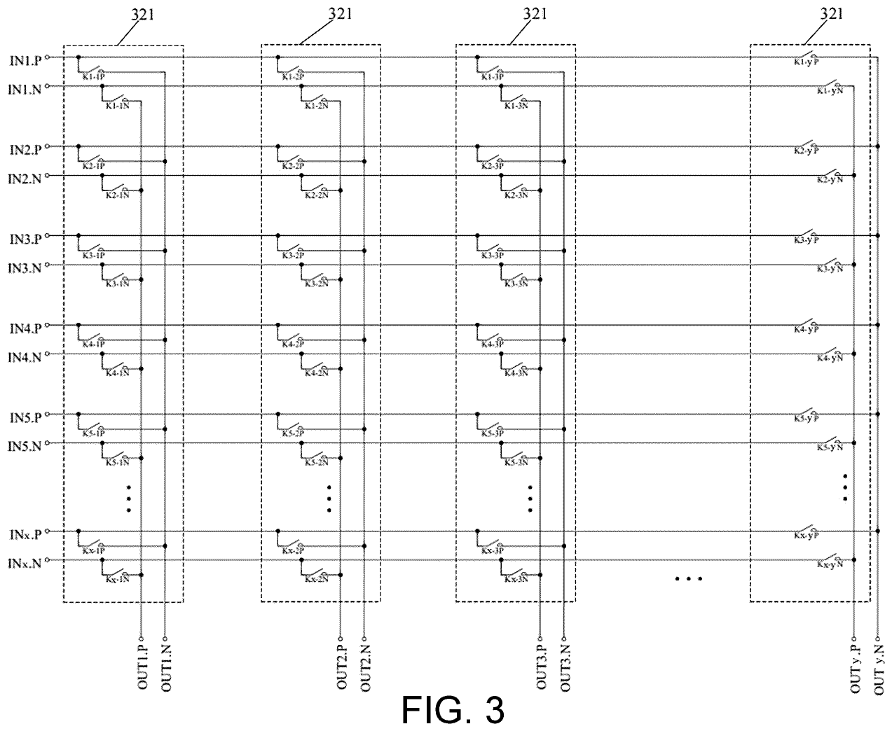

As shown in FIG. 3, the main port INp.P on the first side of the p-th bidirectional DCDC module 10 is connected to the main port OUTq.P of the q-th charging port 20 through the first parallel switch Kp-qP. The secondary port INp.N on the first side of the p-th bidirectional DCDC module 10 is connected to the secondary port OUTq.N of the q-th charging port 20 through the first parallel switch Kp-qN, wherein 1≤p≤X, 1≤q≤Y, and both p and q are integers.

By setting the Y groups of first parallel switch groups 321 including 2X first parallel switches, it is possible for the plurality of series-connected groups of bidirectional DCDC modules 10 realized through the first series switch circuit 31 to achieve increase of parallel current. Also, it is possible to reorganize the main port and the secondary port of the bidirectional DCDC modules 10 that are already connected in series so that they may be connected to the main port and the secondary port of each charging port 20 correspondingly. In the meantime, the first parallel switch may also achieve complete isolation between each charging port 20 and the bidirectional DCDC module 10. It is no longer required for the system to be provided with a main power switch corresponding to the charging port 20, and therefore it is possible to save costs.

In another embodiment of the present disclosure, the first parallel switch circuit 32 may include X groups of first parallel switch groups 321, and one end of each group of first parallel switch groups 321 is connected to the first side of a corresponding bidirectional DCDC module 10, the other ends of each group of the first parallel switch groups 321 is connected to Y charging ports 20 through the first series switch circuit 31. The first parallel switch circuit 32 is configured to realize the parallel connection of any amount of bidirectional DCDC modules 10 on the charging side. The first series switch circuit 31 is connected to the connection line between the first parallel switch circuit 32 and the Y charging ports 20. The first series switch circuit is configured to realize the series connection of the plurality of groups of parallel-connected bidirectional DCDC modules 10, and realize connection between the plurality groups of parallel-connected bidirectional DCDC modules 10 and the corresponding charging ports 20.

As shown in FIG. 1, in an embodiment of the present disclosure, the second series-parallel circuit 40 includes a second series switch circuit 41 and a second parallel switch circuit 42. The second series switch circuit 41 is connected to the connection line between the second side of the X bidirectional DCDC modules 10 and the second parallel switch circuit 42. The second series switch circuit 41 is configured to realize the series connection of any amount of bidirectional DCDC modules 10 on the power supply side. The second parallel switch circuit 42 includes the Z groups of second parallel switch groups. One end of each second parallel switch group is connected to the DC power grid 50, and the other ends of each second parallel switch group is connected to the second side of the X bidirectional DCDC modules 10 through the second series switch circuit 41. The second parallel switch circuit 42 is configured to realize the parallel connection of plurality of groups of bidirectional DCDC modules 10 connected in series, and to connect the plurality of groups of bidirectional CDC modules 10 connected in series to the DC power grid 50, wherein Z is the number of power transmission port groups through which the second series-parallel circuit 40 is connected to the DC power grid 50.

Specifically, the second series switch circuit 41 may include X*(X−1)/2 second series switches, and the main port on the second side of the i-th bidirectional DCDC module 10 is connected to the secondary port on the second side of the i+1-th to X-th bidirectional DCDC modules 10 in one-to-one correspondence through X−i second series switches, wherein 1≤i<X, and i is an integer. For specific implementation of the above, reference may be made to the above-mentioned embodiment of the first series switch circuit 31, which will not be described again here.

Each group of the second parallel switch groups includes 2X second parallel switches, the main port on the second side of each bidirectional DCDC module 10 is connected to each power transmission main port of the DC power grid 50 through the only corresponding second parallel switch, and the secondary port on the second side of each bidirectional DCDC module 10 is connected to each power transmission secondary port of the DC power grid 50 through the only corresponding second parallel switch. For specific implementation of the above, reference may be made to the above-mentioned embodiment of the first parallel switch circuit 32, which will not be described again here.

In an embodiment of the present disclosure, the controller may further be connected to each bidirectional DCDC module 10, so as to obtain the status parameters of the bidirectional DCDC module 10, and perform voltage transformation, power control, etc. on the bidirectional DCDC module 10.

In an embodiment of the present disclosure, the first to X-th bidirectional DCDC modules 10 may further be connected to one or more independent DC power grids through the second series-parallel circuit, so that the bidirectional DCDC module may obtain power supply from one or more independent DC power grids simultaneously, and may also supply power to one or more independent DC power grids simultaneously. When the first to X-th bidirectional DCDC modules are connected to one or more independent DC power grids through the Z groups of second parallel switch groups of the second series-parallel circuit, the number of independent power grids should be less than or equal to Z.

According to the DC bidirectional charging and discharging system of this embodiment, series-parallel circuits are provided on both sides of the bidirectional DCDC module, so that the controller may adjust the output voltage and input voltage of the bidirectional DCDC module by controlling the first series-parallel circuit and the second series-parallel circuit, thereby realizing the wide range of output of the DC bidirectional charging and discharging system, providing full power charging, and switching the input and output of each bidirectional DCDC module at will, so that each bidirectional DCDC module may achieve the maximum charging power or provide charging function for a maximum number of users within each voltage range.

Based on the DC bidirectional charging and discharging system of the above embodiment, the present disclosure further provides a charging pillar.

The charging pillar of the embodiment of the present disclosure includes the DC bidirectional charging and discharging system in any of the above-mentioned embodiments of the present disclosure. For specific implementation of the DC bidirectional charging and discharging system, reference may be made to the above-mentioned embodiments, and related details will not be described again here.

The charging pillar in the embodiment of the present disclosure may realize the wide range of output of the DC bidirectional charging and discharging system, provide full power charging, make it possible for each bidirectional DCDC module to achieve the maximum charging power or provide charging function for a maximum number of users within each voltage range, thereby improving charging and discharging efficiency.

Based on the DC bidirectional charging and discharging system in the above embodiment, the present disclosure further provides a control method for the DC bidirectional charging and discharging system.

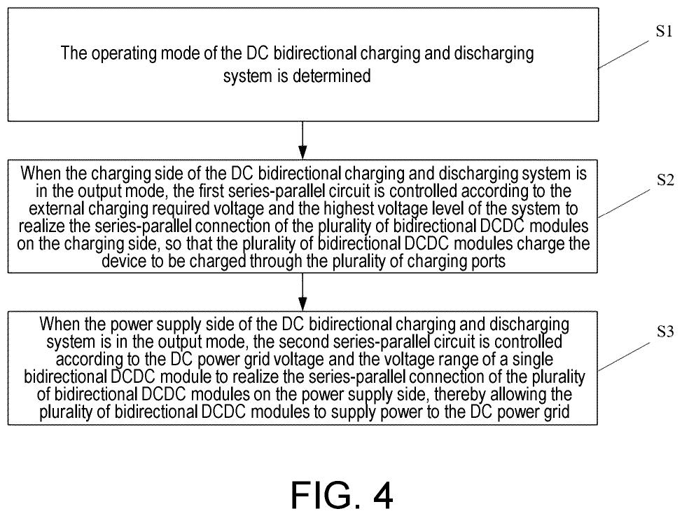

FIG. 4 is a flow chart of a control method for a DC bidirectional charging and discharging system according to an embodiment of the present disclosure. The control method in this embodiment may be used in the DC bidirectional charging and discharging system of any of the above embodiments of the present disclosure. As shown in FIG. 4, the control method includes the following steps.

In step S1, the operating mode of the DC bidirectional charging and discharging system is determined.

When the DC power grid charges the device to be charged through the bidirectional DCDC module and charging port of the DC bidirectional charging and discharging system, the charging side of the DC bidirectional charging and discharging system is in output mode, and the power supply side of the DC bidirectional charging and discharging system is in input mode. When the energy storage device charges the DC power grid through the charging port and the bidirectional DCDC module, the charging side of the DC bidirectional charging and discharging system is in the input mode, and the power supply side of the DC bidirectional charging and discharging system is in the output mode. The charging side of the DC bidirectional charging and discharging system is the side where the bidirectional DCDC module is connected to the charging port through the first series-parallel circuit, and the power supply side of the DC bidirectional charging and discharging system is the side where the bidirectional DCDC module is connected to the DC power grid through the second series-parallel circuit.

In step S2, when the charging side of the DC bidirectional charging and discharging system is in the output mode, the first series-parallel circuit is controlled according to the external charging required voltage and the highest voltage level of the system to realize the series-parallel connection of the plurality of bidirectional DCDC modules on the charging side, so that the plurality of bidirectional DCDC modules charge the device to be charged through the plurality of charging ports.

In an embodiment of the present disclosure, step S2 may specifically include the following steps.

In step S21, the external charging required voltage is obtained.

In step S22, the maximum number u of charging ports that the system can provide for charging and the number v of bidirectional DCDC modules that need to work are determined according to the external charging required voltage and the highest voltage level of the system, wherein the highest voltage level of the system may be determined based on the sum of the highest voltage levels of all bidirectional DCDC modules in the DC bidirectional charging and discharging system.

In a specific embodiment of the present disclosure, the highest voltage level of each bidirectional DCDC module is equal. If the external charging required voltage is the highest voltage level of the system, and one charging port may be provided, then it is determined that all bidirectional DCDC modules are required to supply power for one charging port; if the external charging required voltage is ½ of the highest voltage level of the system, and two charging ports may be provided, then it is determined that ½ of the total number of bidirectional DCDC modules is required to supply power for two charging ports; . . . ; if the external charging required voltage is 1/X of the highest voltage level of the system, and u charging ports may be provided, then it is determined that v bidirectional DCDC modules are required to supply power for the u charging ports, wherein v=[X/u], X is the total number of bidirectional DCDC modules in the DC bidirectional charging and discharging system, Y is the total number of charging ports in the DC bidirectional charging and discharging system, and Y is less than or equal to X, u is an integer greater than or equal to 1 and less than or equal to Y, and v is an integer greater than or equal to 1 and less than or equal to X.

In step S23, the first series-parallel circuit is controlled so that the bidirectional DCDC module that needs to work supplies power to w charging ports that need to be charged.

Specifically, if it is determined that all bidirectional DCDC modules are required to supply power for one charging port, then all bidirectional DCDC modules connected to the first series switch circuit are closed, and one group of the first parallel switch groups connected to the bidirectional DCDC modules is closed; if it is determined that ½ of the total number of bidirectional DCDC modules is required to supply power for two charging ports, then ½ of the total number of adjacent bidirectional DCDC modules connected to the first series switch circuit are closed, and two groups of the first parallel switch groups connected to the bidirectional DCDC modules are closed; . . . ; if it is determined that v bidirectional DCDC modules are required to supply power for w charging ports, then v adjacent bidirectional DCDC modules connected to the first series switch circuit are closed, and the w groups of parallel switch circuit structures connected to the bidirectional DCDC modules are closed.

It should be noted that the number w of charging ports that need to be charged is less than or equal to the maximum number u of charging ports that can serve charging function. When w<u, the determined number of bidirectional DCDC modules that need to work is greater than the number of bidirectional DCDC modules actually required for w charging ports. Charging in this way may effectively improve utilization of the system power while satisfying the external charging required voltage requirements.

In an embodiment of the present disclosure, when the charging side of the DC bidirectional charging and discharging system is in the output mode, the power supply side of the DC bidirectional charging and discharging system is in the input mode, and the second series-parallel circuit may be controlled according to the highest voltage input by the DC power grid. The specific control method may be derived from the control method for the first series-parallel circuit on the charging side in the output mode in the above embodiment, and related details will not be described again here.

In step S24, the output voltage and output power of each bidirectional DCDC module among the bidirectional DCDC modules that need to work are calculated according to the external charging required voltage, the number of charging ports that need to be charged, and the number of bidirectional DCDC modules that provide power for each charging port that may serve the charging function, and each bidirectional DCDC module among the bidirectional DCDC modules that need to work is controlled to work with a corresponding output voltage and output power.

Specifically, the controller may be connected to each bidirectional DCDC module, so as to obtain the status parameters of the bidirectional DCDC module, and perform voltage transformation, power control, etc. on the bidirectional DCDC module.

S3, when the power supply side of the DC bidirectional charging and discharging system is in the output mode, the second series-parallel circuit is controlled according to the required voltage on the power supply side and the voltage range of a single bidirectional DCDC module to realize the series-parallel connection of the plurality of bidirectional DCDC modules on the power supply side, thereby allowing the plurality of bidirectional DCDC modules to supply power to the DC power grid.

In an embodiment of the present disclosure, step S3 may specifically include the following steps.

In step S31, the required voltage on the power supply side is obtained, wherein the required voltage on the power supply side is the required voltage of the DC power grid connected to the DC bidirectional charging and discharging system.

In step S32, the number r of bidirectional DCDC modules connected in series to the DC power grid and the maximum number s of groups of bidirectional DCDC modules connected in parallel to the DC power grid are determined according to the required voltage on the power supply side and the highest voltage level of the system, wherein r is an integer greater than 1 and less than or equal to X, s is an integer greater than or equal to 1 and less than or equal to Z, and Z is the number of power transmission port groups for the second series-parallel circuit to connect to the DC power grid. When the plurality of bidirectional DCDC modules connected in series via the second series switch are connected in parallel through a group of the second parallel switch groups, the bidirectional DCDC modules are formed into a group.

In a specific embodiment of the present disclosure, the highest voltage level of each bidirectional DCDC module is equal, and r and s may be obtained by referring to the calculation method of the specific embodiment in step S22, and related details will not be described again here.

In step S33, the second series-parallel circuit is controlled so that r bidirectional DCDC modules are connected in series to the DC power grid on the power supply side, and s groups of bidirectional DCDC modules are connected in parallel to the DC power grid on the power supply side. The control method of the second series-parallel circuit may be derived from the control method of the first series-parallel circuit in the specific embodiment in step S23, and related details will not be described again here.

In an embodiment of the present disclosure, when the power supply side of the DC bidirectional charging and discharging system is in the output mode, the charging side of the DC bidirectional charging and discharging system is in the input mode, and the first series-parallel circuit may be controlled according to the highest voltage that the external power supply can input through the charging port. The specific control method of the first series-parallel circuit may be derived from the control method of the second series-parallel circuit in the output mode on the power supply side in the above embodiment, and related details will not be described again here.

In an embodiment of the present disclosure, the first to X-th bidirectional DCDC modules are connected to one or more independent DC power grids through the second series-parallel circuit. Under the circumstances, the required voltage on the power supply side is the sum of the required voltages of independent DC power grids connected to the DC bidirectional charging and discharging system. The control method of the second series switch circuit in the second series-parallel circuit may be derived from the control method of the first series switch circuit in the specific embodiment in step S23. There are two situations for the control method of the second parallel switch circuit.

In the first situation, when the number of independent DC power grids connected is equal to s, each group of bidirectional DCDC modules connected in series through the second series switch circuit is assigned to one independent DC power grid and connected thereto.

In the second situation, when the number of independent DC power grids connected is less than s, after each independent DC power grid is assigned a group of series-connected bidirectional DCDC modules, other bidirectional DCDC module groups that are not assigned may further be assigned based on the requirement of the independent DC power grids, thereby achieving control of the second parallel switch circuit and improving the discharging efficiency on the power supply side of the DC bidirectional charging and discharging system.

According to the control method of the DC bidirectional charging and discharging system of this embodiment, the first series-parallel circuit and the second series-parallel circuit are controlled in different operating modes of the DC bidirectional charging and discharging system according to the external charging required voltage or the required voltage on the power supply side. In this way, it is possible to adapt to charging and discharging scenarios with different external charging required voltages and required voltages on the power supply side, thus ensuring effective charging and discharging.

In the description of the present disclosure, “plurality of” means two or more than two, unless otherwise explicitly and specifically limited.

In the present disclosure, unless otherwise clearly stated and limited, the terms “configuration”, “connection”, “linking”, “fixing” and other terms should be understood in a broad sense. For example, they may be a fixed connection or a detachable connection, or integration; they may be a mechanical connection or an electrical connection; they may be a direct connection or an indirect connection through an intermediate medium; they may be an internal connection between two elements or an interaction between two elements.

In the present disclosure, unless otherwise expressly stated and limited, a first feature being “on” or “below” a second feature may mean that the first and second features are in direct contact, or the first and second features are in indirect contact through an intermediate medium. Furthermore, the first feature being “on”, “above” and “on top of” the second feature may mean that the first feature is directly above or diagonally above the second feature, or simply mean that the first feature is higher in level than the second feature. The first feature being “below”, “under” and “beneath” the second feature may mean that the first feature is directly below or diagonally below the second feature, or simply mean that the first feature has a lower horizontal height than the second feature.

The execution order of various steps shown in the flowchart is a preferred implementation. In other embodiments of the present disclosure, the execution order may also be adjusted according to the functions involved in each step. For example, the various steps may be executed simultaneously or in reverse order.

The logic and/or steps indicated in the flowcharts or otherwise described herein, for example, may be considered a sequenced list of executable instructions for implementing the logical functions, and may be embodied in any computer-readable medium for use by or in conjunction with instruction execution systems, devices or equipment. For the purposes of this specification, a “computer-readable medium” may be any device that can contain, store, communicate, propagate, or transmit a program for use by or in connection with an instruction execution system, devices or equipment.

Those of ordinary skill in the art can understand that all or part of the steps involved in implementing the methods of the above embodiments can be completed by instructing relevant hardware through a program. The program can be stored in a computer-readable storage medium. When the program is executed, one of the steps of the method embodiment or a combination thereof is involved.

In addition, each functional unit in various embodiments of the present disclosure can be integrated into a processing module, or each unit can exist physically alone, or two or more units can be integrated into one module. The above integrated modules can be implemented in the form of hardware or software function modules. If the integrated module is implemented in the form of a software function module and sold or used as an independent product, it can also be stored in a computer-readable storage medium.

What is claimed is:

1. A DC bidirectional charging and discharging system, comprising:
first to X-th bidirectional DCDC modules;
first to Y-th charging ports, wherein each of the charging ports is configured to connect to a corresponding device to be charged, wherein X and Y are integers greater than 1;
a first series-parallel circuit, wherein a first side of the first series-parallel circuit is connected to a first side of the X bidirectional DCDC modules, and a second side of the first series-parallel circuit is connected to the Y charging ports to realize an electrical connection between the X bidirectional DCDC modules and the Y charging ports;
a second series-parallel circuit, wherein a first side of the second series-parallel circuit is connected to a DC power grid, and a second side of the second series-parallel circuit is connected to a second side of the X bidirectional DCDC modules to realize an electrical connection between the DC power grid and the X bidirectional DCDC modules;
a controller, wherein the controller is electrically connected to the first series-parallel circuit and the second series-parallel circuit respectively, the controller is configured to control the first series-parallel circuit to realize a series-parallel connection of a plurality of bidirectional DCDC modules on a charging side, and to control the second series-parallel circuit to realize a series-parallel connection of the plurality of bidirectional DCDC modules on a power supply side.

2. The DC bidirectional charging and discharging system according to claim 1, wherein the first series-parallel circuit comprises a first series switch circuit and a first parallel switch circuit,
the first series switch circuit is connected to a connection line between the first side of the X bidirectional DCDC modules and the first parallel switch circuit, the first series switch circuit is configured to realize a series connection of any amount of the bidirectional DCDC modules on the charging side;
the first parallel switch circuit comprises Y groups of first parallel switch groups, and one end of each group of the first parallel switch groups is connected to a corresponding one of the charging ports, other ends of each group of the first parallel switch groups is connected to the first side of the X bidirectional DCDC modules through the first series switch circuit, the first parallel switch circuit is configured to realize a parallel connection of a plurality of groups of the bidirectional DCDC modules connected in series, and to realize a connection of the plurality of groups of the bidirectional DCDC modules connected in series to corresponding charging ports.

3. The DC bidirectional charging and discharging system according to claim 2, wherein the first series switch circuit comprises X*(X−1)/2 first series switches, and a main port on a first side of an i-th bidirectional DCDC module is connected to a secondary port on a first side of an i+1-th bidirectional DCDC module to an X-th bidirectional DCDC module in one-to-one correspondence through X−i first series switches, wherein 1≤i<X, and i is an integer.

4. The DC bidirectional charging and discharging system according claim 3, wherein each group of the first parallel switch groups comprises 2X first parallel switches, a main port on a first side of each of the bidirectional DCDC modules is connected to a main port of each of the charging ports through the only corresponding first parallel switch, and a secondary port on a first side of each of the bidirectional DCDC modules is connected to a secondary port of each of the charging ports through the only corresponding first parallel switch.

5. The DC bidirectional charging and discharging system according to claim 1, wherein the second series-parallel circuit comprise a second series switch circuit and a second parallel switch circuit,
the second series switch circuit is connected to a connection line between the second side of the X bidirectional DCDC modules and the second parallel switch circuit, the second series switch circuit is configured to realize a series connection of any amount of the bidirectional DCDC modules on the power supply side;
the second parallel switch circuit comprises Z groups of second parallel switch groups, one end of each of the second parallel switch groups is connected to the DC power grid, and other ends of each of the second parallel switch groups is connected to the second side of the X bidirectional DCDC modules through the second series switch circuit, the second parallel switch circuit is configured to realize a parallel connection of a plurality of groups of the bidirectional DCDC modules connected in series, and to realize a connection of the plurality of groups of the bidirectional DCDC modules connected in series to the DC power grid, wherein Z is an integer greater than 1.

6. The DC bidirectional charging and discharging system according to claim 1, wherein the first to X-th bidirectional DCDC modules are connected to one or more independent DC power grids through the second series-parallel circuit.

7. A control method for the DC bidirectional charging and discharging system according to claim 1, comprising the following steps:
determining an operating mode of the DC bidirectional charging and discharging system;
when the charging side of the DC bidirectional charging and discharging system is in an output mode, controlling the first series-parallel circuit according to an external charging required voltage and a highest voltage level of the DC bidirectional charging and discharging system to realize the series-parallel connection of the plurality of bidirectional DCDC modules on the charging side, so that the plurality of bidirectional DCDC modules charge a device to be charged through a plurality of charging ports; and
when the power supply side of the DC bidirectional charging and discharging system is in the output mode, controlling the second series-parallel circuit according to a required voltage on the power supply side and the highest voltage level of the DC bidirectional charging and discharging system to realize the series-parallel connection of the plurality of bidirectional DCDC modules on the power supply side, so that the plurality of bidirectional DCDC modules supply power to the DC power grid.

8. The control method for the DC bidirectional charging and discharging system according to claim 7, wherein when the charging side of the DC bidirectional charging and discharging system is in the output mode, controlling the first series-parallel circuit according to the external charging required voltage and the highest voltage level of the DC bidirectional charging and discharging system specifically comprises the following steps:
obtaining the external charging required voltage;
determining a maximum number of charging ports that the DC bidirectional charging and discharging system is able to provide for charging and a number of bidirectional DCDC modules that need to work according to the external charging required voltage and the highest voltage level of the DC bidirectional charging and discharging system;
controlling the first series-parallel circuit so that the bidirectional DCDC module that needs to work supplies power to a charging port that needs to be charged; and
calculating an output voltage and an output power of each bidirectional DCDC module among the bidirectional DCDC modules that need to work according to the external charging required voltage, a number of the charging ports that need to be charged, and the number of the bidirectional DCDC modules that provide power for each of the charging ports that needs to be charged, and controlling each bidirectional DCDC module among the bidirectional DCDC modules that need to work to work with a corresponding output voltage and a corresponding output power.

9. The control method for the DC bidirectional charging and discharging system according to claim 7, wherein when the power supply side of the DC bidirectional charging and discharging system is in the output mode, controlling the second series-parallel circuit according to the required voltage on the power supply side and the highest voltage level of the DC bidirectional charging and discharging system specifically comprises the following steps:
obtaining the required voltage on the power supply side;
determining a number r of bidirectional DCDC modules connected in series to the DC power grid and a maximum number s of groups of bidirectional DCDC modules connected in parallel to the DC power grid according to the required voltage on the power supply side and the highest voltage level of the DC bidirectional charging and discharging system, wherein r is an integer greater than 1 and less than or equal to X, s is an integer greater than or equal to 1 and less than or equal to Z, Z is a number of power transmission port groups through which the second series-parallel circuit is connected to the DC power grid; and
controlling the second series-parallel circuit so that r bidirectional DCDC modules are connected in series to the DC power grid on the power supply side, and s groups of bidirectional DCDC modules are connected in parallel to the DC power grid on the power supply side.

10. A charging pillar, comprising the DC bidirectional charging and discharging system according to claim 1.
